(19) United States
(12) Patent Application Publication
(10) Pub. No.: US 2025/0368445 A1
(43) Pub. Date: Dec. 4, 2025

(54) PRODUCT MANUFACTURING METHOD AND MANUFACTURING SYSTEM

(71) Applicant: SURPASS INDUSTRY CO., LTD., Gyoda-shi (JP)

(72) Inventor: Takashi IMAI, Saitama (JP)

(21) Appl. No.: 19/224,497

(22) Filed: May 30, 2025

(30) Foreign Application Priority Data
May 31, 2024 (JP) 2024-089049

(51) Int. Cl. B65G 1/137; B08B 1/00; B08B 13/00

(52) U.S. Cl. CPC B65G 1/1373; B08B 13/00; B08B 1/00; B65G 2813/00

(57) ABSTRACT

Provided is a product manufacturing method including: first transport step of transporting an enclosure container enclosing a cleaning target to a first storage position in an automated warehouse; second transport step of transporting the enclosure container from the first storage position to a first clean room; cleaning step of cleaning the cleaning target by a cleaning device and accommodating the cleaned cleaning target in an airtight container; third transport step of transporting the enclosure container enclosing the airtight container from the first clean room to a second storage position in the automated warehouse; fourth transport step of transporting the enclosure container from the second storage position to a second clean room; and assembly step of assembling the cleaning target taken out of the airtight container transported to the second clean room in an assembly region to manufacture a product.

### CROSS-REFERENCE TO RELATED APPLICATIONS

This application claims foreign priority benefits under U.S.C. §119 to Japanese Patent Application No. 2024-089049 filed on May 31, 2024, the contents of which is hereby incorporated by reference in its entirety.

### BACKGROUND

### 1. TECHNICAL FIELD

The present disclosure relates to a product manufacturing method and a manufacturing system.

### 2. DESCRIPTION OF RELATED ART

Systems in which a warehouse is installed inside a clean room of a building and articles susceptible to dust are stored in the warehouse are conventionally known (for example, Japanese Patent Application Laid-Open No. H6-144503). Japanese Patent Application Laid-Open No. H6-144503 discloses that articles are taken out of a warehouse as needed, subjected to predetermined machining or treatment, and then carried out of a clean room or temporarily re-stored in the warehouse.

In Japanese Patent Application Laid-Open No. H6-144503, a clean warehouse is installed below a floor plate of the clean room in order to resolve a reduction in the floor area due to installation of a warehouse inside the clean room.

In Japanese Patent Application Laid-Open No. H6-144503, however, the warehouse is installed inside the clean room, and this requires a facility for maintaining the cleanliness of a wide space as a whole including the warehouse and incurs increased installation costs of the facility. On the other hand, if the warehouse is installed outside the clean room, the warehouse is exposed to a general space where the cleanliness of articles that are susceptible to dust is not maintained, and it is thus not possible to maintain the cleanliness of manufactured articles.

### BRIEF SUMMARY

The present disclosure has been made in view of such circumstances and intends to provide a product manufacturing method and a manufacturing system that enable assembly of products while preventing an increase in installation costs due to installation of a warehouse inside a clean room and maintaining the cleanliness of cleaning targets cleaned in the clean room.

The present disclosure employs the following solutions in order to solve the above problems.

A product manufacturing method according to one aspect of the present disclosure includes: a first transport step of transporting an enclosure container enclosing at least one cleaning target to a first storage position in an automated warehouse; a second transport step of transporting the enclosure container from the first storage position to a first clean room, a cleaning device being installed in the first clean room; a cleaning step of cleaning, by the cleaning device, the cleaning target taken out of the enclosure container transported by the second transport step, accommodating the cleaned cleaning target in an airtight container, and enclosing the airtight container in the enclosure container; a third transport step of transporting the enclosure container enclosing the airtight container from the first clean room to a second storage position in the automated warehouse; a fourth transport step of transporting the enclosure container from the second storage position to a second clean room having an assembly region used for assembling the cleaning target; and an assembly step of taking the cleaning target out of the airtight container enclosed in the enclosure container transported to the second clean room by the fourth transport step and assembling the cleaning target in the assembly region to manufacture a product.

According to the product manufacturing method of one aspect of the present disclosure, the enclosure container enclosing a cleaning target is transported to the first storage position in the automated warehouse in the first transport step. The cleaning target taken out of the enclosure container transported from the first storage position to the first clean room in the second transport step is cleaned by the cleaning device, accommodated in the airtight container, and enclosed in the enclosure container together with the airtight container in the cleaning step.

In the third transport step, the enclosure container enclosing the airtight container is transported from the first clean room to the second storage position in the automated warehouse. In the third transport step, although the enclosure container is transported from the first clean room to the general environment in which the automated warehouse is arranged, the cleaned cleaning target is accommodated in the airtight container. Thus, the cleanliness of the cleaning target stored in the automated warehouse can be maintained.

The enclosure container enclosing the airtight container is transported from the second storage position to the second clean room in the fourth transport step, and the cleaning target taken out of the airtight container is assembled as a product in the assembly region in the assembly step. As such, while the cleaning target cleaned in the first clean room is stored in the automated warehouse arranged in the external general environment, the cleaning target can be transported to the second clean room and assembled as the product as needed.

As described above, according to the product manufacturing method of one aspect of the present disclosure, the product can be assembled with the cleanliness of the cleaning target cleaned in the clean room being maintained, while an increase in installation costs due to installation of the warehouse inside the clean room is prevented.

The product manufacturing method according to one aspect of the present disclosure may be configured such that a plurality of cleaning targets are enclosed in the enclosure container, and the product manufacturing method includes: a fifth transport step of transporting the enclosure container enclosing the airtight container accommodating the remaining cleaning targets, which are other than the cleaning targets used in the assembly step, from the second clean room to a third storage position in the automated warehouse.

According to the product manufacturing method of the above configuration, out of a plurality of cleaning targets enclosed in the enclosure container, only some of the cleaning targets to be used in the assembly step can be taken out of the airtight container, and the remaining cleaning targets can be stored suitably in the automated warehouse while the cleanliness of the remaining cleaning targets is maintained.

The product manufacturing method according to one aspect of the present disclosure may be configured such that the enclosure container has a first body and a first lid, the first body enclosing the airtight container, a first opening opened upward being formed in the first body, and the first lid being attached above the first body so as to seal the first opening, and the fourth transport step blows air to the first lid when the enclosure container passes through an airlock room arranged between a storage space in which the automated warehouse is arranged and the second clean room.

According to the product manufacturing method of the above configuration, since the first opening formed upward in the first body of the enclosure container is sealed with the first lid, this prevents dust from entering the inside of the first body of the enclosure container during storage in the automated warehouse. Further, since air is blown to the first lid of the enclosure container passing through the airlock room in the fourth transport step, the enclosure container is transported to the second clean room in a state where dust deposited on the first lid during storage in the automated warehouse has been removed, and thereby entry of dust into the second clean room can be prevented.

The product manufacturing method of the above configuration may be formed such that the airtight container has a second body, a second lid, and a holding part, the second body accommodating the cleaning target, a second opening opened upward being formed in the second body, the second lid being attached above the second body so as to seal the second opening, and the holding part being configured to hold a sealed state where the second opening is sealed with the second lid, a protruding part formed endlessly so as to surround the second opening and protruding upward is formed to the top face of the second body, an elastic member configured to come into contact with the protruding part and elastically deform when sealing the second opening is attached to the second lid, and when the sealed state is held by the holding part, the protruding part and the elastic member come into contact with each other and form an endless seal region surrounding the second opening.

According to the product manufacturing method of the above form, the second opening formed upward in the second body of the airtight container is sealed with the second lid, and the sealed state is held by the holding part. Further, when the sealed state is held by the holding part, the protruding part of the second body and the elastic member of the second lid come into contact with each other and form an endless seal region surrounding the second opening. Thus, the cleanliness inside the airtight container during storage in the automated warehouse can be reliably maintained.

The product manufacturing method according to one aspect of the present disclosure may be configured such that the first clean room and the second clean room are arranged on the same floor of a building, and the automated warehouse is arranged on a floor above or below the first clean room and the second clean room.

According to the product manufacturing method of the above configuration, the first clean room and the second clean room are arranged on the same floor of a building, and the automated warehouse is arranged on the floor above or below the floor of these clean rooms. This can reduce the building area of the building required for storage of the cleaning targets and manufacturing of the products.

A manufacturing system according to one aspect of the present disclosure includes: a first clean room in which a cleaning device configured to clean at least one cleaning target is installed; a second clean room having an assembly region used for assembling the cleaning target cleaned by the cleaning device to manufacture a product; an automated warehouse configured to store an enclosure container enclosing the cleaning target at a predetermined storage position and transport the enclosure container to a predetermined transport destination; and a control device configured to control transportation of the enclosure container in the automated warehouse, and the control device performs control to transport the enclosure container enclosing the cleaning target manufactured in the machining room to a first storage position in the automated warehouse, transport the enclosure container from the first storage position to the first clean room, transport the enclosure container enclosing an airtight container accommodating the cleaning target cleaned by the cleaning device from the first clean room to a second storage position in the automated warehouse, and transport the enclosure container from the second storage position to the second clean room.

According to the manufacturing system of one aspect of the present disclosure, the enclosure container enclosing the cleaning target is transported to the first storage position in the automated warehouse. The cleaning target taken out of the enclosure container transported from the first storage position to the first clean room is cleaned by the cleaning device, accommodated in the airtight container, and enclosed in the enclosure container together with the airtight container.

Although the enclosure container enclosing the airtight container is transported from the first clean room to the general environment in which the automated warehouse is arranged, the cleaned cleaning target is accommodated in the airtight container. Thus, the cleanliness of the cleaning target stored in the automated warehouse can be maintained.

The enclosure container enclosing the airtight container is transported from the second storage position to the second clean room, and the cleaning target taken out of the airtight container is assembled as a product in the assembly region. As such, while the cleaning target cleaned in the first clean room is stored in the automated warehouse arranged in the external general environment, the cleaning target can be transported to the second clean room and assembled as the product as needed.

As described above, according to the manufacturing system of one aspect of the present disclosure, the product can be assembled with the cleanliness of the cleaning target cleaned in the clean room being maintained while an increase in installation costs due to installation of the warehouse inside the clean room is prevented.

The manufacturing system according to one aspect of the present disclosure may be configured such that a plurality of cleaning targets are enclosed in the enclosure container transported to the first storage position, and the control device performs control to transport the enclosure container enclosing the airtight container accommodating the remaining cleaning targets, which are other than the cleaning targets used in the assembly region, from the second clean room to a third storage position in the automated warehouse.

According to the manufacturing system of the above configuration, out of a plurality of cleaning targets enclosed in the enclosure container, only some of the cleaning targets to be used in the assembly region can be taken out of the airtight container, and the remaining cleaning targets can be stored suitably in the automated warehouse while the cleanliness of the remaining cleaning targets is maintained.

The manufacturing system according to one aspect of the present disclosure may be configured such that the enclosure container has a first body and a first lid, the first body enclosing the airtight container, a first opening opened upward being formed in the first body, and the first lid being attached above the first body so as to seal the first opening, the manufacturing system includes an airlock space arranged between a storage space in which the automated warehouse is arranged and the second clean room, and a blow device is arranged in the airlock space, the blow device being configured to blow air to the first lid when the enclosure container passes through the airlock space.

According to the product manufacturing system of the above configuration, since the first opening formed upward in the first body of the enclosure container is sealed with the first lid, this prevents dust from entering the inside of the first body of the enclosure container during storage in the automated warehouse. Further, since air is blown to the first lid of the enclosure container passing through the airlock room, the enclosure container is transported to the second clean room in a state where dust deposited on the first lid during storage in the automated warehouse has been removed, and thereby entry of dust into the second clean room can be prevented.

The manufacturing system of the above configuration may be formed such that the airtight container has a second body, a second lid, and a holding part, the second body accommodating the cleaning target, a second opening opened upward being formed in the second body, the second lid being attached above the second body so as to seal the second opening, and the holding part being configured to hold a sealed state where the second opening is sealed with the second lid, a protruding part formed endlessly so as to surround the second opening and protruding upward is formed to the top face of the second body, an elastic member configured to come into contact with the protruding part and elastically deform when sealing the second opening is attached to the bottom face of the second lid, and when the sealed state is held by the holding part, the protruding part and the elastic member come into contact with each other and form an endless seal region surrounding the second opening.

According to the manufacturing system of the above form, the second opening formed upward in the second body of the airtight container is sealed with the second lid, and the sealed state is held by the holding part. Further, when the sealed state is held by the holding part, the protruding part of the second body and the elastic member of the second lid come into contact with each other and form an endless seal region surrounding the second opening. Thus, the cleanliness inside the airtight container during storage in the automated warehouse can be reliably maintained.

The manufacturing system according to one aspect of the present disclosure may be configured such that the first clean room and the second clean room are arranged on the same floor of a building, and the automated warehouse is arranged on a floor above or below the first clean room and the second clean room.

According to the manufacturing system of the above configuration, the first clean room and the second clean room are arranged on the same floor of a building, and the automated warehouse is arranged on the floor above or below the floor of these clean rooms. This can reduce the building area of the building required for storage of the cleaning targets and manufacturing of the products.

According to the present disclosure, it is possible to provide a product manufacturing method and a manufacturing system that enable assembly of products while preventing an increase in installation costs due to installation of a warehouse inside a clean room and maintaining the cleanliness of cleaning targets cleaned in the clean room.

### BRIEF DESCRIPTION OF THE SEVERAL VIEWS OF THE DRAWINGS

FIG. 1 is a schematic sectional view illustrating a manufacturing system according to one embodiment of the present disclosure.

FIG. 2 is a flowchart illustrating a product manufacturing method according to one embodiment of the present disclosure.

FIG. 3 is a front view illustrating an enclosure container enclosing machined components and illustrates a state where an airtight container is accommodated in the enclosure container.

FIG. 4 is a sectional view of the enclosure container and the airtight container illustrated in FIG. 3.

FIG. 5 is a sectional view illustrating a state where a first lid has been detached from the enclosure container illustrated in FIG. 4 and a second lid has been detached from the airtight container.

### DETAILED DESCRIPTION

A manufacturing system 100 according to one embodiment of the present disclosure will be described below with reference to the drawings. The manufacturing system 100 of the present embodiment is, for example, a system that machines a raw material such as a resin material (fluororesin material or the like) to manufacture machined components (cleaning targets) P and cleans and then assembles the manufactured machined components P together with further components to manufacture products G.

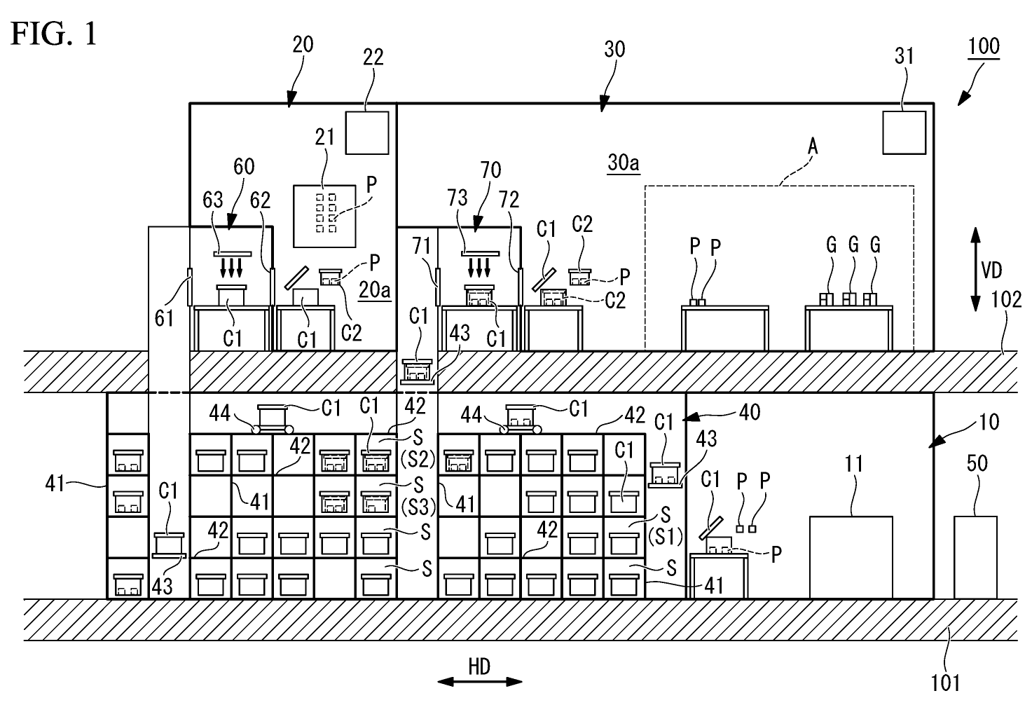

As illustrated in FIG. 1, the manufacturing system 100 includes a machining room 10, a first clean room 20, a second clean room 30, an automated warehouse 40, a control device 50, a first airlock room 60, and a second airlock room 70. As illustrated in FIG. 1, in the manufacturing system 100, the first clean room 20 and the second clean room 30 are arranged on a second floor-face 102 on the same floor of a building.

On the other hand, the machining room 10 and the automated warehouse 40 are arranged on a first floor-face 101 on the floor below the first clean room 20 and the second clean room 30. Note that the machining room 10 and the automated warehouse 40 may be arranged on a floor above the first clean room 20 and the second clean room 30.

The machining room 10 is a room in which a machining device 11 that machines a raw material to manufacture machined components P is installed. For example, the machining device 11 performs cutting or drilling on a resin material, which is a raw material, to manufacture machined components P. For example, the machining device 11 may be a device that molds a resin material into a desired shape by injection molding. A plurality of machined components P manufactured by the machining device 11 are enclosed in enclosure containers C1 by an operator(s) (not illustrated).

The first clean room 20 is a room in which a cleaning device 21 that cleans machined components P is installed. In the first clean room 20, a ventilation device 22 is installed that holds the internal space 20a at a positive pressure higher than the atmospheric pressure and filtrates out particulate substances floating in the internal space 20a. It is desirable for the ventilation device to have performance that achieves, for example, Class 7 or lower in ISO 14644-1:2015 for the cleanliness class of the internal space 20a.

The cleaning device 21 is a device that cleans machined components P multiple times by a cleaning liquid (for example, pure water). The operator brings the machined components P cleaned and then dried by the cleaning device 21 to be accommodated in an airtight container C2 within the first clean room 20 so that the machined components P do not communicate with the outside. Because the machined components P are accommodated in the airtight container C2, the inside of the airtight container C2 can be maintained at substantially the same cleanliness as the internal space 20a of the first clean room 20 even when the enclosure container C1 enclosing the airtight container C2 is stored in a general environment (where the cleanliness is Class 8 or higher in ISO 14644-1:2015) in which the automated warehouse 40 is arranged.

The second clean room 30 is a room having an assembly region A used for the operator to assemble the machined components P cleaned by the cleaning device 21 and then accommodated in the airtight container C2 together with further components. The operator takes the machined components P out of the airtight container C2 enclosed in the enclosure container C1 transported from the automated warehouse 40 to the second clean room 30 and assembles the machined components P with further components to manufacture the products G.

In the second clean room 30, a ventilation device 31 is installed that holds the internal space 30a at a positive pressure higher than the atmospheric pressure and filtrates out particulate substances floating in the internal space 30a. It is desirable for the ventilation device to have performance that achieves, for example, Class 7 or lower in ISO 14644-1:2015 for the cleanliness class of the internal space 30a.

The automated warehouse 40 is a device for storing enclosure containers C1 enclosing machined components at a predetermined storage position and transporting the enclosure containers C1 to a predetermined transport destination. As illustrated in FIG. 1, the automated warehouse 40 has a plurality of storage positions S for storing the enclosure containers C1. The plurality of storage positions S are partitioned by a plurality of vertical frames 41 and a plurality of horizontal frames 42.

The automated warehouse 40 has storage positions S of 4 rows in the vertical direction VD by 11 columns in the horizontal direction HD by a predetermined number of columns in the depth direction (not illustrated). The automated warehouse 40 has a motion mechanism (not illustrated) that moves the enclosure container C1 stored at a predetermined storage position S to any other storage position S.

The automated warehouse 40 has a lift mechanism 43 that moves the enclosure container C1 taken out from each storage position S to any position in the vertical direction VD and a transport mechanism 44 that moves the enclosure container C1 in the horizontal direction HD along the horizontal frame 42 arranged at the highest position in the vertical direction VD.

The control device 50 is a device that controls transport of enclosure containers C1 in the automated warehouse 40. The control device 50 controls the motion mechanism to move the enclosure containers C1 stored at a predetermined storage position S to any other storage position S. Further, the control device 50 controls the lift mechanism 43 to move the enclosure containers C1 taken out from each storage position S to any position in the vertical direction. Further, the control device 50 controls the transport mechanism 44 to move the enclosure container C1 in the horizontal direction HD.

The first airlock room 60 is a room that is provided between the internal space 20a held at the positive pressure higher than an atmospheric pressure and the general environment having the automated warehouse 40 arranged therein and being at the atmospheric pressure and is used for adjusting a pressure difference between the internal space 20a and the general environment. The first airlock room 60 has an open/close door 61, an open/close door 62, and an air shower (blow device) 63 respectively controlled by the control device 50.

When transporting the enclosure container C1 from the general environment to the internal space 20a, the control device 50 opens the open/close door 61 with the open/close door 62 being left closed and carries the enclosure container C1 into the first airlock room 60. The control device 50 closes the open/close door 61 after carrying the enclosure container C1 into the first airlock room 60 and operates the air shower 63 for a predetermined time. The air shower 63 blows air to the enclosure container C1 to remove dust attached to the enclosure container C1.

The control device 50 then opens the open/close door 62 with the open/close door 61 being left closed and carries the enclosure container C1 into the first clean room 20. The control device 50 closes the open/close door 62 after carrying the enclosure container C1 into the first clean room 20.

When transporting the enclosure container C1 from the internal space 20a to the general environment, the control device 50 opens the open/close door 62 with the open/close door 61 being left closed and carries the enclosure container C1 into the first airlock room 60. The control device 50 closes the open/close door 62 after carrying the enclosure container C1 into the first airlock room 60 and then opens the open/close door 61. The control device 50 closes the open/close door 61 after carrying the enclosure container C1 out of the first airlock room 60.

The second airlock room 70 is a room that is provided between the internal space 30a held at the positive pressure higher than an atmospheric pressure and the general environment having the automated warehouse 40 arranged therein and being at the atmospheric pressure and is used for adjusting a pressure difference between the internal space 30a and the general environment. The second airlock room 70 has an open/close door 71, an open/close door 72, and an air shower (blow device) 73 respectively controlled by the control device 50.

When transporting the enclosure container C1 from the general environment to the internal space 30a, the control device 50 opens the open/close door 71 with the open/close door 72 being left closed and carries the enclosure container C1 into the second airlock room 70. The control device 50 closes the open/close door 71 after carrying the enclosure container C1 into the second airlock room 70 and operates the air shower 73 for a predetermined time. The air shower 73 blows air to the enclosure container C1 to remove dust attached to the enclosure container C1.

The control device 50 then opens the open/close door 72 with the open/close door 71 being left closed and carries the enclosure container C1 into the second clean room 30. The control device 50 closes the open/close door 72 after carrying the enclosure container C1 into the second clean room 30.

When transporting the enclosure container C1 from the internal space 30a to the general environment, the control device 50 opens the open/close door 72 with the open/close door 71 being left closed and carries the enclosure container C1 into the second airlock room 70. The control device 50 closes the open/close door 72 after carrying the enclosure container C1 into the second airlock room 70 and then opens the open/close door 71. The control device 50 closes the open/close door 71 after carrying the enclosure container C1 out of the second airlock room 70.

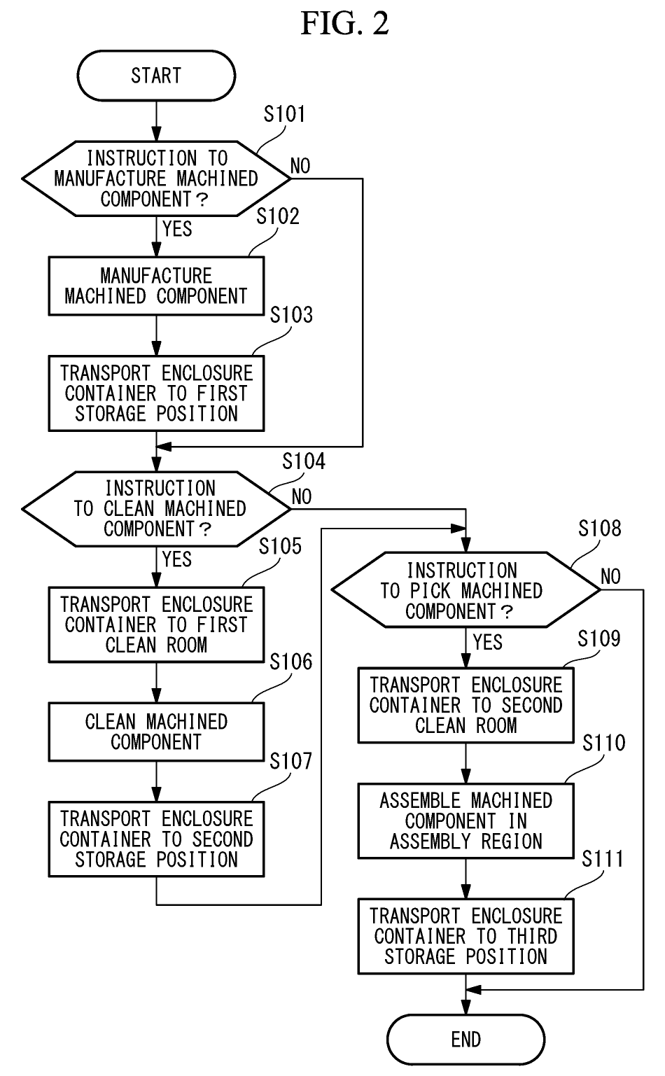

Next, the manufacturing method performed by the manufacturing system 100 of the present embodiment will be described with reference to the drawings. FIG. 2 is a flowchart illustrating the product manufacturing method according to one embodiment of the present disclosure. When the control device 50 executes a control program stored in the storage unit (not illustrated), each process illustrated in FIG. 2 is performed.

In step S101, the control device 50 determines whether or not an instruction to manufacture the machined component P is provided by the operator of the manufacturing system 100 and, if the determination is YES, proceeds with the process to step S102 or, if the determination is NO, proceeds with the process to step S104.

In step S102 (machining step), the control device 50 controls the machining device 11 to manufacture the machined component P by the machining device 11 installed in the machining room 10. In step S102, the control device 50 transfers the instruction to manufacture the machined component P to the machining device 11 installed in the machining room 10. The operator of the machining room 10 supplies a raw material to the machining device 11 in accordance with the instruction of manufacturing displayed on a display unit (not illustrated) of the machining device 11. The operator encloses one or a plurality of machined components P manufactured by the machining device 11 in the enclosure container C1.

In step S103 (first transport step), the control device 50 controls the automated warehouse 40 to transport the enclosure container C1 enclosing the one or more machined components P to the first storage position S1 in the automated warehouse 40. The first storage position S1 can be any position of the plurality of storage positions S included in the automated warehouse 40.

In step S104, the control device 50 determines whether or not an instruction to clean the machined component P is provided by the operator of the manufacturing system 100 and, if the determination is YES, proceeds with the process to step S105 or, if the determination is NO, proceeds with the process to step S108.

In step S105 (second transport step), the control device 50 controls the automated warehouse 40 to transport the enclosure container C1 from the first storage position S1 to the first clean room 20 in which the cleaning device 21 is installed. The control device 50 carries the enclosure container C1 from the first storage position S1 into the first airlock room 60 and carries the enclosure container C1 from the first airlock room 60 into the internal space 20a of the first clean room 20.

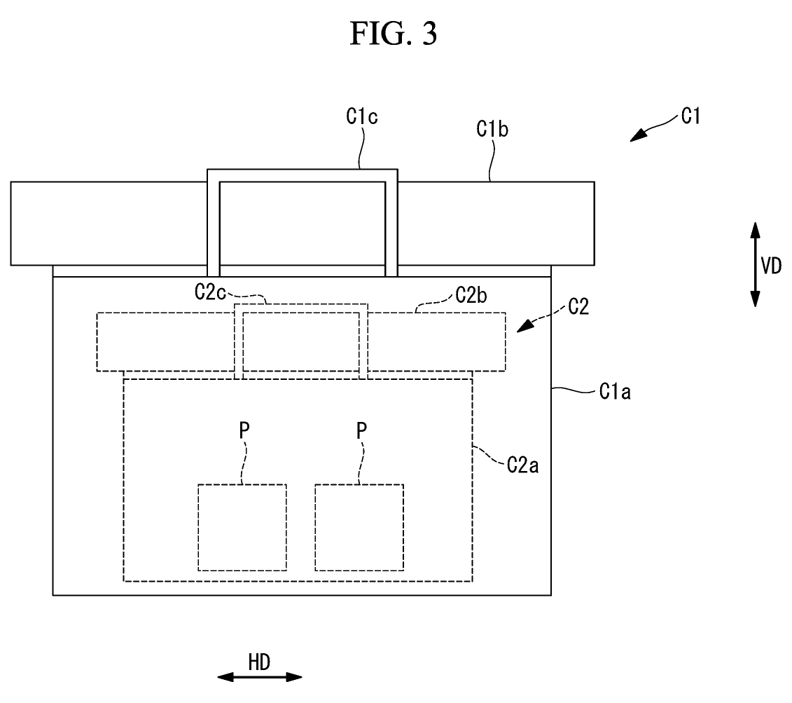

During the enclosure container C1 passing through the first airlock room 60, air is blown to the first lid C1b of the enclosure container C1 (see FIG. 3 to FIG. 5) by the air shower 63. Dust deposited on the enclosure container C1 is removed by the air blown by the air shower 63.

In step S106 (cleaning step), the control device 50 controls the cleaning device 21 to use the cleaning device 21 installed in the first clean room 20 to clean the machined component P taken out of the enclosure container C1. In step S106, the control device 50 transfers the instruction to clean the machined component P to the cleaning device 21. The operator of the first clean room 20 supplies the machined component P taken out of the enclosure container C1 to the cleaning device 21 in accordance with the instruction of cleaning displayed on the display unit (not illustrated) of the cleaning device 21.

The operator accommodates the one or plurality of machined components P cleaned by the cleaning device 21 in the airtight container C2. Further, the operator encloses the airtight container C2 in the enclosure container C1. The airtight container C2 is a container for isolating the cleaned machined component P from outside of the airtight container C2 so as to maintain substantially the same cleanliness as the internal space 20a of the first clean room 20. The structure of the airtight container C2 will be described later.

In step S107 (third transport step), the control device 50 controls the automated warehouse 40 to transport the enclosure container C1 enclosing the airtight container C2 to a second storage position S2 in the automated warehouse 40. The second storage position S2 can be any position of the plurality of storage positions S included in the automated warehouse 40.

In step S108, the control device 50 determines whether or not an instruction to pick the machined component P is provided by the operator of the manufacturing system 100 and, if the determination is YES, proceeds with the process to step S109 or, if the determination is NO, ends the process of the present flowchart.

In step S109 (fourth transport step), the control device 50 controls the automated warehouse 40 to transport the enclosure container C1 from the second storage position S2 to the second clean room 30 having the assembly region A used for assembling the machined component P together with further components. The control device 50 carries the enclosure container C1 from the second storage position S2 into the second airlock room 70 and carries the enclosure container C1 from the second airlock room 70 into the internal space 30a of the second clean room 30.

During the enclosure container C1 passing through the second airlock room 70, air is blown to the first lid C1b of the enclosure container C1 (see FIG. 3 to FIG. 5) by the air shower 73. Dust deposited on the enclosure container C1 is removed by the air blown by the air shower 73.

In step S110 (assembly step), the operator takes machined components P out of the airtight container C2 enclosed in the enclosure container C1 transported to the second clean room 30. Further, the operator assembles the machined components P together with further components in the assembly region A to manufacture the products G. When the number of machined components P used in assembly of the products G is less than the number of machined components P enclosed in the airtight container C2 transported to the second clean room 30, the operator encloses the airtight container C2 accommodating one or more remaining machined components P, which are other than the used machined component(s) P, in the enclosure container C1.

In step S111 (fifth transport step), the control device 50 controls the automated warehouse 40 to transport the enclosure container C1 enclosing the airtight container C2 to a third storage position S3 in the automated warehouse 40. The third storage position S3 can be any position of the plurality of storage positions S included in the automated warehouse 40. After performing step S111, the control device 50 ends the process of the present flowchart.

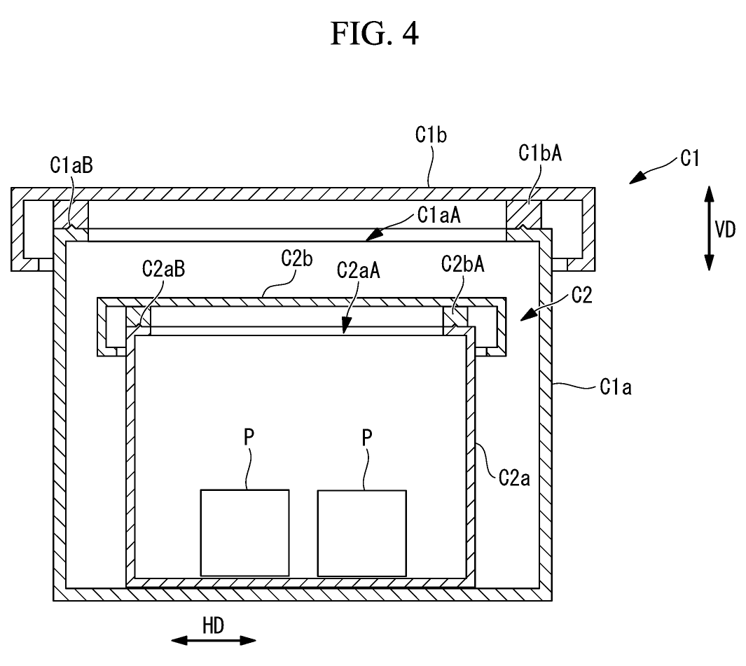

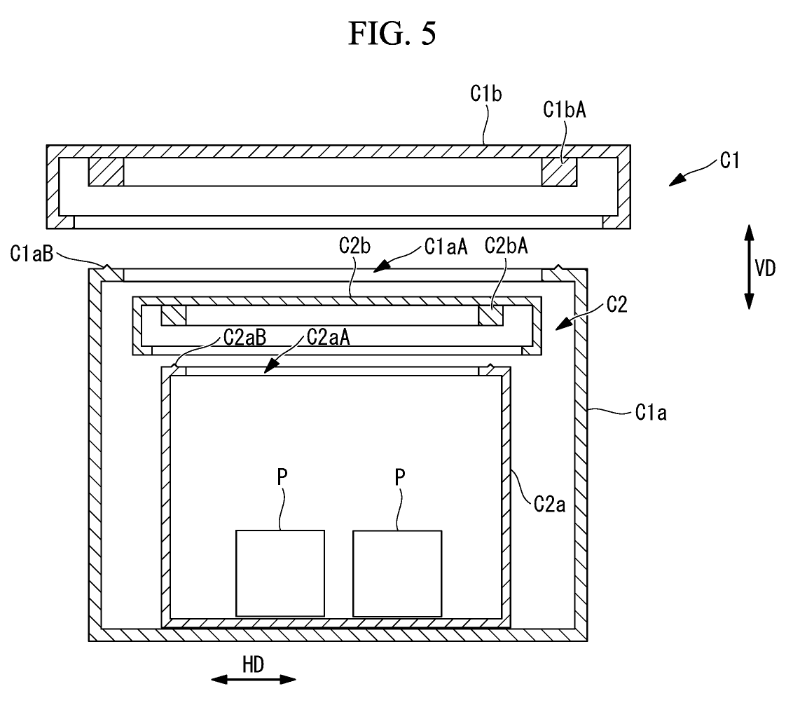

Next, the structure of the enclosure container C1 and the airtight container C2 of the present embodiment will be described with reference to the drawings. FIG. 3 is a front view illustrating the enclosure container C1 enclosing machined components P and illustrates a state where the airtight container C2 is accommodated in the enclosure container C1. FIG. 4 is a sectional view of the enclosure container C1 and the airtight container C2 illustrated in FIG. 3. FIG. 5 is a sectional view illustrating a state where the first lid C1b has been detached from the enclosure container C1 illustrated in FIG. 4 and the second lid C2b has been detached from the airtight container C2.

As illustrated in FIG. 3 to FIG. 5, the enclosure container C1 has a first body C1a, the first lid C1b, and a first holding part C1c and, for example, is formed of a resin material. The first body C1a is a casing that encloses the airtight container C2 and has a first opening C1aA opened upward in the vertical direction VD formed therein.

The first lid C1b is a member attached above the first body C1a so as to seal the first opening C1aA. The first holding part C1c is a member that holds a sealed state where the first opening C1aA is sealed with the first lid C1b. The first holding part C1c is fixed to the first body C1a and fixes the first lid C1b to the first body C1a with the first opening C1aA being sealed with the first lid C1b.

As illustrated in FIG. 4 and FIG. 5, a first protruding part C1aB formed endlessly so as to surround the first opening C1aA and protruding upward is formed to the top face of the first body C1a. A first packing (elastic member) C1bA configured to come into contact with the first protruding part C1aB and elastically deform when sealing the first opening C1aA is attached to the bottom face of the first lid C1b. When the sealed state of the enclosure container C1 is held by the first holding part C1c, the first protruding part C1aB and the first packing C1bA come into contact with each other and thereby form an endless first seal region surrounding the first opening C1aA.

As illustrated in FIG. 3 to FIG. 5, the airtight container C2 has a second body C2a, the second lid C2b, and a second holding part C2c and, for example, is formed of a resin material. The second body C2a is a casing that encloses the machined components P and has a second opening C2aA opened upward in the vertical direction VD formed therein.

The second lid C2b is a member attached above the second body C2a so as to seal the second opening C2aA. The second holding part C2c is a member that holds a sealed state where the second opening C2aA is sealed with the second lid C2b. The second holding part C2c is fixed to the second body C2a and fixes the second lid C2b to the second body C2a with the second opening C2aA being sealed with the second lid C2b.

As illustrated in FIG. 4 and FIG. 5, a second protruding part C2aB formed endlessly so as to surround the second opening C2aA and protruding upward is formed to the top face of the second body C2a. A second packing (elastic member) C2bA configured to come into contact with the second protruding part C2aB and elastically deform when sealing the second opening C2aA is attached to the bottom face of the second lid C2b. When the sealed state of the airtight container C2 is held by the second holding part C2c, the second protruding part C2aB and the second packing C2bA come into contact with each other and thereby form an endless second seal region surrounding the second opening C2aA.

According to the manufacturing method for manufacturing the product G using the manufacturing system 100 of the present embodiment described above, the following effects and advantages are achieved.

According to the manufacturing method of the present embodiment, the machined component P manufactured by the machining device 11 is enclosed in the enclosure container C1 and transported to the first storage position S1 in the automated warehouse 40. The machined component P taken out of the enclosure container C1 transported from the first storage position S1 to the first clean room 20 is cleaned by the cleaning device 21, accommodated in the airtight container C2, and enclosed in the enclosure container C1 together with the airtight container C2.

Although the enclosure container C1 enclosing the airtight container C2 is transported from the first clean room 20 to the general environment in which the automated warehouse 40 is arranged, the cleaned machined component P is accommodated in the airtight container C2. Thus, the cleanliness of the machined component P stored in the automated warehouse 40 can be maintained.

The enclosure container C1 enclosing the airtight container C2 is transported from the second storage position S2 to the second clean room 30, and the machined component P taken out of the airtight container C2 is assembled as the product G in the assembly region A. As such, while the machined component P cleaned in the first clean room 20 is stored in the automated warehouse 40 arranged in the external general environment, the machined component P can be transported to the second clean room 30 and assembled as the product G as needed.

As described above, according to the manufacturing method of the present embodiment, the product can be assembled with the cleanliness of the machined component P cleaned in the clean room being maintained while an increase in installation costs due to installation of a warehouse inside a clean room is prevented.

Further, according to the manufacturing method of the present embodiment, out of a plurality of machined components P enclosed in the enclosure container C1, only some of the machined components P to be used in the assembly region A can be taken out of the airtight container C2, and the remaining machined components P can be stored in the automated warehouse 40 while the cleanliness of the remaining machined components P is maintained.

Further, according to the manufacturing method of the present embodiment, since the first opening C1aA formed upward in the first body C1a of the enclosure container C1 is sealed with the first lid C1b, this prevents dust from entering the inside of the first body C1a of the enclosure container C1 during storage in the automated warehouse 40. Further, since air is blown to the first lid C1b of the enclosure container C1 passing through the second airlock room 70, the enclosure container C1 is transported to the second clean room 30 in a state where dust deposited on the first lid C1b during storage in the automated warehouse 40 has been removed, and thereby entry of dust into the second clean room 30 can be prevented.

Further, according to the manufacturing method of the present embodiment, the second opening C2aA formed upward in the second body C2a of the airtight container C2 is sealed with the second lid C2b, and the sealed state is held by the second holding part C2c. Further, when the sealed state is held by the second holding part C2c, the second protruding part C2aB of the second body C2a and the second packing C2bA of the second lid C2b come into contact with each other and form an endless second seal region surrounding the second opening C2aA. Thus, the cleanliness inside the airtight container C2 during storage in the automated warehouse 40 can be reliably maintained.

Further, according to the manufacturing method of the present embodiment, the first clean room 20 and the second clean room 30 are arranged on the same floor of a building, and the automated warehouse 40 is arranged on the floor above or below these clean rooms. This can reduce the building area of the building required for storage of the machined components P and manufacturing of the products G.

### Other Embodiments

Although the machined component P machined in the machining room 10 is enclosed in the enclosure container C1, then transported to the first clean room 20, and cleaned by the cleaning device 21 in the above description, other forms may be employed. For example, the cleaning target to be transported to the first clean room 20 and cleaned by the cleaning device 21 may be a different component other than the machined component P machined in the machining room 10.

Specifically, the cleaning target may be a cleaning target manufactured outside in advance, such as O-rings or other components each being one of the components assembled as the product G. When the product G is a fluid device that causes a liquid to flow through therein, any component with which the liquid is in contact during the use of the product G may be the cleaning target.

Although the enclosure container C1 is configured such that, when the sealed state is held with the first holding part C1c, the first protruding part C1aB and the first packing C1bA come into contact with each other and form the endless first seal region surrounding the first opening C1aA in the above description, other forms may be employed. For example, the enclosure container C1 having none of the first protruding part C1aB, the first packing C1bA, nor the first holding part C1c may be employed. In such a case, the enclosure container C1 takes a form in which the first lid C1b is stacked on the top face of the first body C1a. Furthermore, as the enclosure container C1, an enclosure container having only the first body C1a and not having the first lid C1b may be employed.

Further, an electroconductive resin material may be used as the material forming the enclosure container C1 and the airtight container C2 described above. With the use of the electroconductive resin material as the material of the containers, static electricity charged in components accommodated in the container is externally discharged, and thereby damage to the components due to static electricity can be prevented. Further, for example, an electroconductive sheet may be installed on the bottom face of the body of the container, and such a structure that electrically conducts the electroconductive sheet with the outside of the container through a conductive part may be employed.

What is claimed is:

1. A product manufacturing method comprising:
a first transport step of transporting an enclosure container enclosing at least one cleaning target to a first storage position in an automated warehouse;
a second transport step of transporting the enclosure container from the first storage position to a first clean room, a cleaning device being installed in the first clean room;
a cleaning step of cleaning, by the cleaning device, the cleaning target taken out of the enclosure container transported by the second transport step, accommodating the cleaned cleaning target in an airtight container, and enclosing the airtight container in the enclosure container;
a third transport step of transporting the enclosure container enclosing the airtight container from the first clean room to a second storage position in the automated warehouse;
a fourth transport step of transporting the enclosure container from the second storage position to a second clean room having an assembly region used for assembling the cleaning target; and
an assembly step of taking the cleaning target out of the airtight container enclosed in the enclosure container transported to the second clean room by the fourth transport step and assembling the cleaning target in the assembly region to manufacture a product.

2. The product manufacturing method according to claim 1, wherein a plurality of cleaning targets are enclosed in the enclosure container, the product manufacturing method further comprising:
a fifth transport step of transporting the enclosure container enclosing the airtight container accommodating the remaining cleaning targets, which are other than the cleaning targets used in the assembly step, from the second clean room to a third storage position in the automated warehouse.

3. The product manufacturing method according to claim 1,
wherein the enclosure container has a first body and a first lid, the first body enclosing the airtight container, a first opening opened upward being formed in the first body, and the first lid being attached above the first body so as to seal the first opening, and
wherein the fourth transport step blows air to the first lid when the enclosure container passes through an airlock room arranged between a space in which the automated warehouse is arranged and the second clean room.

4. The product manufacturing method according to claim 3,
wherein the airtight container has a second body, a second lid, and a holding part, the second body accommodating the cleaning target, a second opening opened upward being formed in the second body, the second lid being attached above the second body so as to seal the second opening, and the holding part being configured to hold a sealed state where the second opening is sealed with the second lid,
wherein a protruding part formed endlessly so as to surround the second opening and protruding upward is formed to the top face of the second body,
wherein an elastic member configured to come into contact with the protruding part and elastically deform when sealing the second opening is attached to the bottom face of the second lid, and
wherein when the sealed state is held by the holding part, the protruding part and the elastic member come into contact with each other and form an endless seal region surrounding the second opening.

5. The product manufacturing method according to claim 1,
wherein the first clean room and the second clean room are arranged on the same floor of a building, and
wherein the automated warehouse is arranged on a floor above or below the first clean room and the second clean room.

6. A manufacturing system comprising:
a first clean room in which a cleaning device configured to clean at least one cleaning target is installed;
a second clean room having an assembly region used for assembling the cleaning target cleaned by the cleaning device to manufacture a product;
an automated warehouse configured to store an enclosure container enclosing the cleaning target at a predetermined storage position and transport the enclosure container to a predetermined transport destination; and
a control device configured to control transportation of the enclosure container in the automated warehouse,
wherein the control device performs control to
transport the enclosure container enclosing the cleaning target to a first storage position in the automated warehouse,
transport the enclosure container from the first storage position to the first clean room,
transport the enclosure container enclosing an airtight container accommodating the cleaning target cleaned by the cleaning device from the first clean room to a second storage position in the automated warehouse, and
transport the enclosure container from the second storage position to the second clean room.

7. The manufacturing system according to claim 6,
wherein a plurality of cleaning targets are enclosed in the enclosure container transported to the first storage position, and
wherein the control device performs control to transport the enclosure container enclosing the airtight container accommodating the remaining cleaning targets, which are other than the cleaning targets used in the assembly region, from the second clean room to a third storage position in the automated warehouse.

8. The manufacturing system according to claim 6,
wherein the enclosure container has a first body and a first lid, the first body enclosing the airtight container, a first opening opened upward being formed in the first body, and the first lid being attached above the first body so as to seal the first opening,
the manufacturing system further comprising:
an airlock space arranged between a storage space in which the automated warehouse is arranged and the second clean room,
wherein a blow device is arranged in the airlock space, the blow device being configured to blow air to the first lid when the enclosure container passes through the airlock space.

9. The manufacturing system according to claim 8,
wherein the airtight container has a second body, a second lid, and a holding part, the second body accommodating the cleaning target, a second opening opened upward being formed in the second body, the second lid being attached above the second body so as to seal the second opening, and the holding part being configured to hold a sealed state where the second opening is sealed with the second lid,
wherein a protruding part formed endlessly so as to surround the second opening and protruding upward is formed to the top face of the second body,
wherein an elastic member configured to come into contact with the protruding part and elastically deform when sealing the second opening is attached to the second lid, and
wherein when the sealed state is held by the holding part, the protruding part and the elastic member come into contact with each other and form an endless seal region surrounding the second opening.

10. The manufacturing system according to claim 6,
wherein the first clean room and the second clean room are arranged on the same floor of a building, and
wherein the automated warehouse is arranged on a floor above or below the first clean room and the second clean room.
